(19) United States
(12) Patent Application Publication
(10) Pub. No.: US 2008/0126811 A1
(43) Pub. Date: May 29, 2008

(54) METHOD FOR AUTHORIZED-USER VERIFICATION AND RELATED APPARATUS

(76) Inventors: Wei Chang, Hsinchu City (TW); Nai-Sheng Cheng, Hsinchu City (TW); Steve Wiyi Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/736,569

(22) Filed: Apr. 17, 2007

(30) Foreign Application Priority Data
Nov. 24, 2006 (TW) 095143562

(51) Int. Cl. H04L 9/32

(52) U.S. Cl. 713/186

(57) ABSTRACT

The invention discloses a method for authorized-user verification, which allows a host-end system to determine whether a holder of a user-end apparatus is an authorized user. The method includes: the host-end system sending a secret code to the user-end apparatus; the user-end apparatus scanning at least one biometric characteristic of the holder, generating encrypted data according to the secret code and the biometric characteristic, and sending the encrypted data to the host-end system; the host-end system decrypting the encrypted data to generate a decrypted secret code and a decrypted biometric characteristic, checking whether the decrypted secret code matches the secret code, and further checking whether the decrypted biometric characteristic matches a pre-stored biometric characteristic of the authorized user when the decrypted secret code matches the secret code.

### BACKGROUND OF THE INVENTION

1. Field of the Invention

The invention relates to identity verification of an authorized user, and more particularly, to an authorized-user verification method applying biometric characteristics and secret codes, and related authorized-user verification apparatus.

2. Description of the Prior Art

In recent years, non-contact communication utilizing radio signals has become a fast developing technical field, wherein near field communication (NFC) technology is applied in more and more transaction modes. NFC is a communication at short range, and the transaction utilizing NFC is therefore called an NFC transaction. For example, VISA finance cards and smart cards utilized in the Taipei rapid transit system are examples of NFC transaction applications.

However, the NFC transaction is still limited to transactions that involve a small amount of money. In addition to misgivings of security such as risks of data being divulged during the NFC transaction (for example, the data might be copied by criminals), the main misgiving is that the system is not able to verify whether the user of the transaction is an authorized user, and when the transaction carrier is stolen, there exists a risk of losing money. All of these security problems will increase the misgivings of the users and merchants when they use an NFC transaction. Therefore, some people in academic circles and in the industry are devoted to providing a thoroughly considered transaction method in order to increase the transaction security of the NFC transaction.

### SUMMARY OF THE INVENTION

It is therefore one of the objectives of the present invention to provide a method for a host-end system to determine whether a holder of a user-end apparatus is an authorized user, and related authorized-user verification apparatus.

According to an embodiment of the present invention, a method for authorized-user verification, which allows a host-end system to determine whether a holder of a user-end apparatus is an authorized user, is disclosed. The method includes: the host-end system sending a secret code to the user-end apparatus; the user-end apparatus scanning at least one biometric characteristic of the holder; the user-end apparatus generating encrypted data according to the secret code and the biometric characteristic; the user-end apparatus sending the encrypted data to the host-end system; the host-end system decrypting the encrypted data to generate a decrypted secret code and a decrypted biometric characteristic; the host-end system checking whether the decrypted secret code matches the secret code; and the host-end system further checking whether the decrypted biometric characteristic matches a pre-stored biometric characteristic of the authorized user to determine whether the holder is the authorized user if the decrypted secret code matches the secret code.

According to an embodiment of the present invention, a method for authorized-user verification, which allows a host-end system to determine whether a holder of a user-end apparatus is an authorized user, is further disclosed. The method includes: the host-end system sending a secret code to the user-end apparatus; the user-end apparatus scanning a biometric characteristic of the holder; the user-end apparatus checking whether the biometric characteristic matches a pre-stored biometric characteristic, the pre-stored biometric characteristic being stored in the user-end apparatus; the user-end apparatus generating encrypted data according to the secret code and a key value stored in the user-end apparatus if the biometric characteristic matches the pre-stored biometric characteristic; the user-end apparatus sending the encrypted data to the host-end system; the host-end system decrypting the encrypted data to generate a decrypted secret code and a decrypted key value; the host-end system checking whether the decrypted secret code matches the secret code; and the host-end system further checking whether the decrypted key value matches a pre-stored key value of the authorized user to determine whether the holder is the authorized user if the decrypted secret code matches the secret code.

According to an embodiment of the present invention, an authorized-user verification apparatus, which allows a host-end system to determine whether a holder of a user-end apparatus is an authorized user, is disclosed. The authorized-user verification apparatus includes: a transceiver, for receiving a secret code from the host-end system and send encrypted data to the host-end system; a biometric characteristic sensor, for scanning at least one biometric characteristic of the holder; and an encryption module, coupled to the transceiver and the biometric characteristic sensor, for generating the encrypted data according to the secret code and the biometric characteristic; wherein the host-end system determines whether the holder is the authorized user according to the encrypted data.

According to an embodiment of the present invention, an authorized-user verification apparatus, which allows a host-end system to determine whether a holder of a user-end apparatus is an authorized user, is further disclosed. The authorized-user verification apparatus includes: a transceiver, for receiving a secret code from the host-end system and send encrypted data to the host-end system; a biometric characteristic sensor, for scanning a biometric characteristic of the holder; a security apparatus, for storing a pre-stored biometric characteristic and a key value of the authorized user; an identification module, coupled to the biometric characteristic sensor and the security apparatus, for determining whether the biometric characteristic matches the pre-stored biometric characteristic; and an encryption module, coupled to the identification module, the security apparatus, and the transceiver, for generating the encrypted data according to the secret code and the key value when the biometric characteristic matches the pre-stored biometric characteristic; wherein the host-end system determines whether the holder is the authorized user according to the encrypted data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a transaction system according to a first embodiment of the present invention.

FIG. 2 is an example of a flow chart executed by the transaction system shown in FIG. 1.

FIG. 3 is a block diagram of a transaction system according to a second embodiment of the present invention.

FIG. 4 is an example of a flow chart executed by the transaction system shown in FIG. 3.

### DETAILED DESCRIPTION

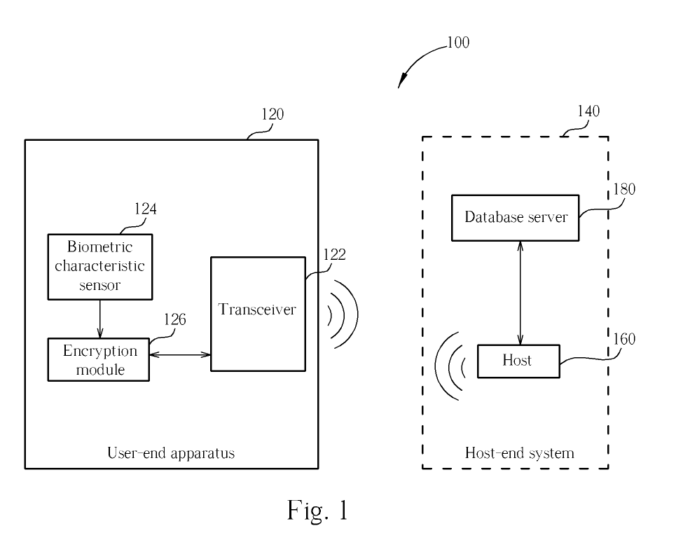

Please refer to FIG. 1. FIG. 1 is a block diagram of a transaction system according to a first embodiment of the present invention. In this embodiment, the transaction system 100 includes a user-end apparatus 120 and a host-end system 140, wherein the user-end apparatus 120 is utilized to verify an authorized user, and the user-end apparatus 120 can be a portable electronic apparatus. The user-end apparatus 120 includes a transceiver 122, a biometric characteristic sensor 124, and an encryption module 126, and the host-end system 140 includes a host 160 and a database server 180.

The NFC transceiver is an example of the transceiver 122, and the NFC transceiver can allow the user-end apparatus 120 and the host 160 to perform communication according to an NFC protocol. The communication is performed via a network between the host 160 and the database server 180 (the network has security above a certain level). The radio frequency identity (RFID) can be an example of the NFC protocol mentioned above.

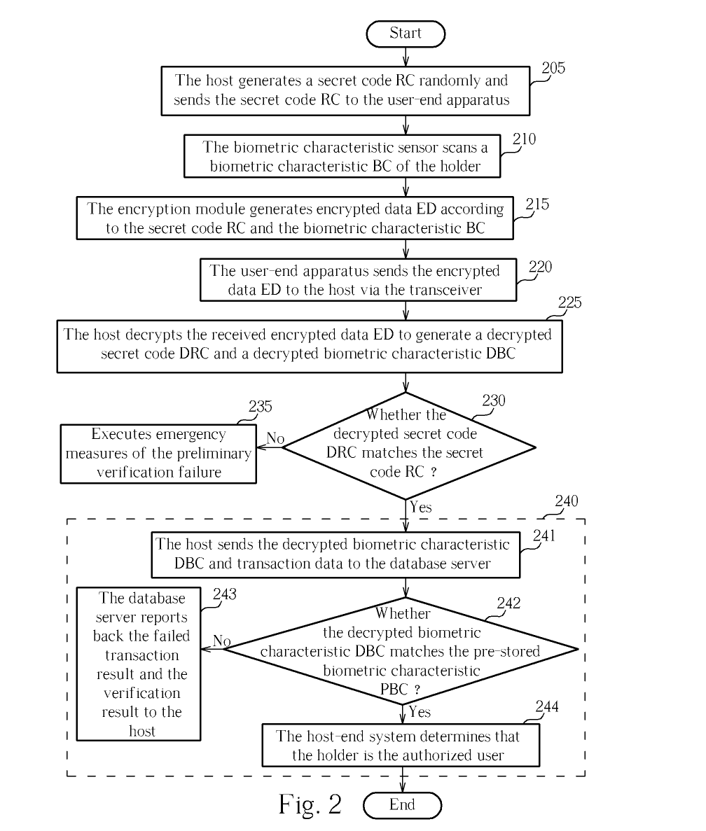

Please refer to FIG. 2. FIG. 2 is an example of a flow chart executed by the transaction system 100 when a holder of the user-end apparatus 120 wants to carry out the transaction. The host-end system 140 will be able to determine whether the holder is an authorized user via the flow chart. The flow chart includes the following steps:

Step 205: The host 160 generates a secret code RC randomly and sends the secret code RC to the transceiver 122 of the user-end apparatus 120; wherein, the secret code RC can be a default value or a value generated according to a specific operation. In a preferred embodiment, the secret code RC can be a random value changing with time.

Step 210: The biometric characteristic sensor 124 scans a biometric characteristic BC of the holder. For example, the biometric characteristic BC can be fingerprints, voiceprints, retinas, face characteristics, or other biometric characteristics of the holder. In a preferred embodiment, the biometric characteristic sensor can scan more than one biometric characteristic.

Step 215: The encryption module 126 generates encrypted data ED according to the secret code RC and the biometric characteristic BC; wherein, the encryption module can generate the encrypted data ED according to more than one or two kinds of the biometric characteristic BC.

Step 220: The user-end apparatus 120 sends the encrypted data ED to the host 160 via the transceiver 122.

Step 225: The host 160 decrypts the received encrypted data ED to generate a decrypted secret code DRC and a decrypted biometric characteristic DBC.

Step 230: The host 160 checks whether the decrypted secret code DRC matches the secret code RC generated before. If the decrypted secret code DRC does not match the secret code RC, then it means that the preliminary verification fails, and the flow enters step 235; if the decrypted secret code DRC matches the secret code RC, then it means that the preliminary verification succeeds, and the flow enters step 240.

Step 235: Entering this step means that the preliminary verification fails, and at this time the transaction system 100 executes emergency measures of the preliminary verification failure such as going back to step 205 in order to restart the flow chart, announcing that the transaction fails, or executing other emergency measures.

Step 240: Entering this step means that the preliminary verification succeeds, and at this time the host-end system 140 will further check whether the decrypted biometric characteristic DBC matches a pre-stored biometric characteristic PBC of the authorized user to determine whether the holder is the authorized user; wherein, when the encrypted data ED is generated by more than two kinds of the biometric characteristic BC, the pre-stored biometric characteristic PBC will also have a corresponding amount. In this example, the step 240 includes sub-step 241, sub-step 242, sub-step 243, and sub-step 244. In the sub-step 241, the host 160 sends the decrypted biometric characteristic DBC and transaction data to the database server 180. In the sub-step 242, the database server 180 checks whether the decrypted biometric characteristic DBC matches the pre-stored biometric characteristic PBC stored in the database server 180; If the decrypted biometric characteristic DBC does not match the pre-stored biometric characteristic PBC, then the flow enters sub-step 243; if the decrypted biometric characteristic DBC matches the pre-stored biometric characteristic PBC, then the flow enters sub-step 244. In the sub-step 243, since it is checked that the decrypted biometric characteristic DBC does not match the pre-stored biometric characteristic PBC, the host-end system 140 determines that the holder is not the authorized user, and the database server 180 will report back the failed transaction result and the verification result to the host 160 (or execute other emergency measures). In the sub-step 244, since it is checked that the decrypted biometric characteristic DBC matches the pre-stored biometric characteristic PBC, the host-end system 140 can determine that the holder is the authorized user, and the database server 180 can report back the transaction result and the verification result to the host 160.

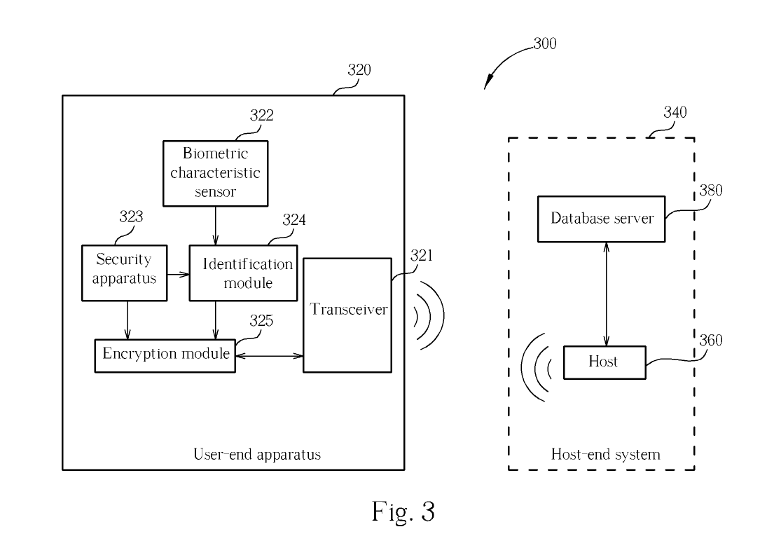

Please refer to FIG. 3. FIG. 3 is a block diagram of a transaction system according to a second embodiment of the present invention. In this embodiment, the transaction system 300 includes a user-end apparatus 320 and a host-end system 340, wherein the user-end apparatus 320 is utilized to verify an authorized user, and the user-end apparatus 320 can be a portable electronic apparatus. The user-end apparatus 320 includes a transceiver 321, a biometric characteristic sensor 322, a security apparatus 323, an identification module 324, and an encryption module 325, and the host-end system 340 includes a host 360 and a database server 380. For example, the security apparatus 323 can be a SIM card or an IC.

The NFC transceiver is an example of the transceiver 321, and the NFC transceiver can allow the user-end apparatus 320 and the host 360 to perform communication according to an NFC protocol. The communication is performed via a network between the host 360 and the database server 380 (the network has security above a certain level). The radio frequency identity (RFID) can be an example of the NFC protocol mentioned above.

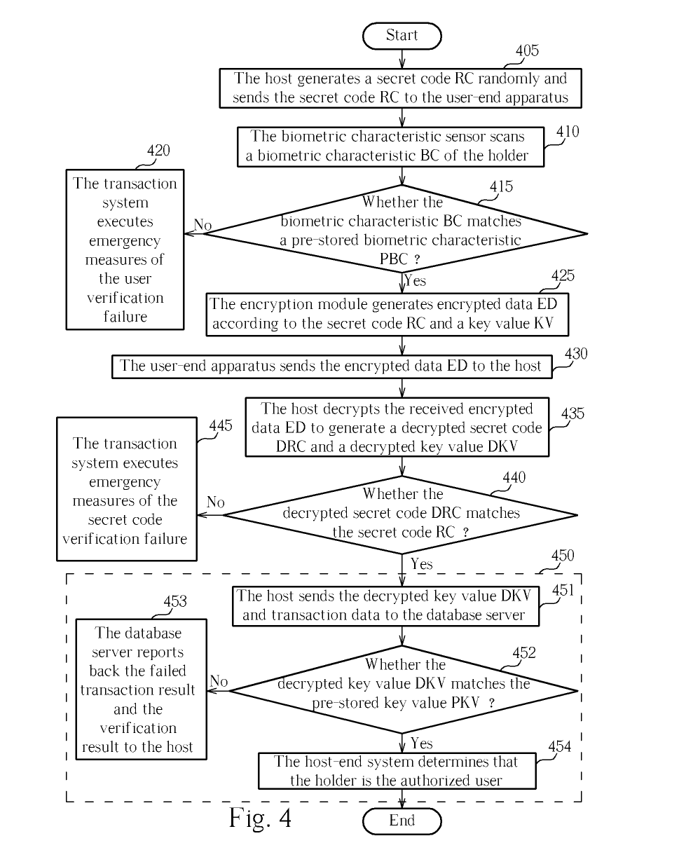

Please refer to FIG. 4. FIG. 4 is an example of a flow chart executed by the transaction system 300 when a holder of the user-end apparatus 320 wants to carry out the transaction. The host-end system 340 will be able to determine whether the holder is an authorized user via the flow chart. The flow chart includes the following steps:

Step 405: The host 360 generates a secret code RC randomly and sends the secret code RC to the transceiver 321 of the user-end apparatus 320; wherein, the secret code RC can be a default value or a value generated according to a specific operation. In a preferred embodiment, the secret code RC can be a random value changing with time.

Step 410: The biometric characteristic sensor 322 scans a biometric characteristic BC of the holder. For example, the biometric characteristic BC can be fingerprints, voiceprints, retinas, face characteristics, or other characteristics of the holder.

Step 415: The identification module 324 determines whether the biometric characteristic BC matches a pre-stored biometric characteristic PBC stored in the security apparatus 323; wherein, the pre-stored biometric characteristic PBC is the biometric characteristic of the authorized user, and an unauthorized user is not able to change the data stored in the security apparatus 323. If the biometric characteristic BC does not match the pre-stored biometric characteristic PBC, then it means that the user verification fails, and the flow then enters step 420; if the biometric characteristic BC matches the pre-stored biometric characteristic PBC, then it means that the user verification succeeds, and the flow then enters step 425.

Step 420: When entering this step, it means that the user verification fails, and at this time the transaction system 300 executes emergency measures of the user verification failure such as going back to step 405 in order to restart the flow chart, announcing that the transaction fails, or executing other emergency measures.

Step 425: The encryption module 325 generates encrypted data ED according to the secret code RC and a key value KV of the security apparatus 323.

Step 430: The user-end apparatus 320 sends the encrypted data ED to the host 360 via the transceiver 321.

Step 435: The host 360 decrypts the received encrypted data ED to generate a decrypted secret code DRC and a decrypted key value DKV.

Step 440: The host 160 checks whether the decrypted secret code DRC matches the secret code RC generated before. If the decrypted secret code DRC does not match the secret code RC, then it means that the secret code verification fails, and the flow then enters step 445; if the decrypted secret code DRC matches the secret code RC, then it means that the secret code verification succeeds, and the flow then enters step 450.

Step 445: Entering this step means that the secret code verification fails, and at this time the transaction system 300 executes emergency measures of the secret code verification failure such as going back to step 405 in order to restart the flow chart, announcing that the transaction fails, or executing other emergency measures.

Step 450: Entering this step means that the secret code verification succeeds, and at this time the host-end system 340 will further check whether the decrypted key value DKV matches a pre-stored key value PKV of the authorized user to determine whether the holder is the authorized user. In this example, the step 450 includes sub-step 451, sub-step 452, sub-step 453, and sub-step 454. In sub-step 451, the host 360 sends the decrypted key value DKV and transaction data to the database server 380. In sub-step 452, the database server 380 checks whether the decrypted key value DKV matches the pre-stored key value PKV stored in the database server 380; If the decrypted key value DKV does not match the pre-stored key value PKV, the flow then enters sub-step 453; if the decrypted key value DKV matches the pre-stored key value PKV, the flow then enters sub-step 454. In the sub-step 453, since it is checked that the decrypted key value DKV does not match the pre-stored key value PKV, the host-end system 340 determines that the holder is not the authorized user, and the database server 380 will report back the failed transaction result and the verification result to the host 360 (or execute other emergency measures). In the sub-step 454, since it is checked that the decrypted key value DKV matches the pre-stored key value PKV, the host-end system 340 can determine that the holder is the authorized user, and the database server 380 can report back the transaction result and the verification result to the host 360.

As the secret code generation, the biometric characteristic scan, and the data encryption/decryption are applied in the flow chart of each embodiment mentioned above, the transaction system according to the embodiments of the present invention is able to prevent the user-end apparatus from being embezzled by the unauthorized users, and prevent the transaction data from being copied by criminals. In other words, the transaction system according to the embodiments of the present invention is able to provide better security for performing the NFC transaction.

Those skilled in the art will readily observe that numerous modifications and alterations of the apparatus and method may be made while retaining the teachings of the invention. Accordingly, the above disclosure should be construed as limited only by the metes and bounds of the appended claims.

What is claimed is:

1. A method for authorized-user verification, which allows a host-end system to determine whether a holder of a user-end apparatus is an authorized user, the method comprising:
the host-end system sending a secret code to the user-end apparatus;
the user-end apparatus scanning at least one biometric characteristic of the holder;
the user-end apparatus generating encrypted data according to the secret code and the biometric characteristic;
the user-end apparatus sending the encrypted data to the host-end system;
the host-end system decrypting the encrypted data to generate a decrypted secret code and a decrypted biometric characteristic;
the host-end system checking whether the decrypted secret code matches the secret code; and
the host-end system further checking whether the decrypted biometric characteristic matches a pre-stored biometric characteristic of the authorized user to determine whether the holder is the authorized user if the decrypted secret code matches the secret code.

2. The method of claim 1, wherein the host-end system and the user-end apparatus receive and send the secret code and the encrypted data according to a near field communication (NFC) protocol.

3. The method of claim 1, wherein the host-end system and the user-end apparatus receive and send the secret code and the encrypted data according to a radio frequency identity (RFID) protocol.

4. The method of claim 1, wherein the user-end apparatus is a portable electronic apparatus.

5. The method of claim 1 being applied in a NFC transaction.

6. The method of claim 1, wherein the secret code is a value generated according to a specific operation.

7. The method of claim 1, wherein the secret code is a random value changing with time.

8. A method for authorized-user verification, which allows a host-end system to determine whether a holder of a user-end apparatus is an authorized user, the method comprising:
the host-end system sending a secret code to the user-end apparatus;
the user-end apparatus scanning a biometric characteristic of the holder;
the user-end apparatus checking whether the biometric characteristic matches a pre-stored biometric characteristic, the pre-stored biometric characteristic being stored in the user-end apparatus;
the user-end apparatus generating encrypted data according to the secret code and a key value stored in the user-end apparatus if the biometric characteristic matches the pre-stored biometric characteristic;
the user-end apparatus sending the encrypted data to the host-end system;
the host-end system decrypting the encrypted data to generate a decrypted secret code and a decrypted key value;
the host-end system checking whether the decrypted secret code matches the secret code; and
the host-end system further checking whether the decrypted key value matches a pre-stored key value of the authorized user to determine whether the holder is the authorized user if the decrypted secret code matches the secret code.

9. The method of claim 8, wherein the host-end system and the user-end apparatus receive and send the secret code and the encrypted data according to an NFC protocol.

10. The method of claim 8, wherein the host-end system and the user-end apparatus receive and send the secret code and the encrypted data according to an RFID protocol.

11. The method of claim 8, wherein the user-end apparatus includes a security apparatus, and the pre-stored biometric characteristic and the key value are stored in the security apparatus.

12. The method of claim 8, wherein the user-end apparatus is a portable electronic apparatus.

13. The method of claim 8, wherein the secret code is a value generated according to a specific operation.

14. The method of claim 8, wherein the secret code is a random value changing with time.

15. An authorized-user verification apparatus, which allows a host-end system to determine whether a holder of a user-end apparatus is an authorized user, the authorized-user verification apparatus comprising:
a transceiver, for receiving a secret code from the host-end system and sending encrypted data to the host-end system;
a biometric characteristic sensor, for scanning at least one biometric characteristic of the holder; and
an encryption module, coupled to the transceiver and the biometric characteristic sensor, for generating the encrypted data according to the secret code and the biometric characteristic;
wherein the host-end system determines whether the holder is the authorized user according to the encrypted data.

16. The authorized-user verification apparatus of claim 15, wherein the transceiver is an NFC transceiver.

17. The authorized-user verification apparatus of claim 15, wherein the transceiver receives and sends the secret code and the encrypted data according to an RFID protocol.

18. The authorized-user verification apparatus of claim 15 being a portable electronic apparatus.

19. An authorized-user verification apparatus, which allows a host-end system to determine whether a holder of a user-end apparatus is an authorized user, the authorized-user verification apparatus comprising:
a transceiver, for receiving a secret code from the host-end system and send encrypted data to the host-end system;
a biometric characteristic sensor, for scanning a biometric characteristic of the holder;
a security apparatus, for storing a pre-stored biometric characteristic and a key value of the authorized user;
an identification module, coupled to the biometric characteristic sensor and the security apparatus, for determining whether the biometric characteristic matches the pre-stored biometric characteristic; and
an encryption module, coupled to the identification module, the security apparatus, and the transceiver, for generating the encrypted data according to the secret code and the key value when the biometric characteristic matches the pre-stored biometric characteristic;
wherein the host-end system determines whether the holder is the authorized user according to the encrypted data.

20. The authorized-user verification apparatus of claim 19, wherein the transceiver is a NFC transceiver.

21. The authorized-user verification apparatus of claim 19, wherein the transceiver receives and sends the secret code and the encrypted data according to an RFID protocol.

22. The authorized-user verification apparatus of claim 19 being a portable electronic apparatus.

23. A method for authorized-user verification, which allows a host-end system to determine whether a holder of a user-end apparatus is an authorized user, the method implemented in the user-end apparatus, the method comprising:
receiving a secret code;
scanning at least one biometric characteristic of the holder;
generating encrypted data according to the secret code and the biometric characteristic; and
sending out the encrypted data.

24. The method of claim 23, wherein the secret code is sent from the host-end system.

25. The method of claim 23, wherein the encrypted data is sent to the host-end system.
